(19) United States
(12) Patent Application Publication
(10) Pub. No.: US 2024/0077764 A1
(43) Pub. Date: Mar. 7, 2024

(54) DIMMING LAYER FOR DISPLAY MODULE AND DISPLAY MODULE

(71) Applicant: WUHAN CHINA STAR OPTOELECTRONICS TECHNOLOGY CO., LTD., Wuhan (CN)

(72) Inventors: Wei CHENG, Wuhan (CN); Mei LIU, Wuhan (CN)

(73) Assignee: WUHAN CHINA STAR OPTOELECTRONICS TECHNOLOGY CO., LTD., Wuhan (CN)

(21) Appl. No.: 17/294,403

(22) PCT Filed: Apr. 20, 2021
(86) PCT No.: PCT/CN2021/088325

§ 371 Date: Nov. 14, 2023

(30) Foreign Application Priority Data
Mar. 31, 2021 (CN) 202110352223.4

(51) Int. Cl. G02F 1/13357; G02F 1/1334

(52) U.S. Cl. CPC G02F 1/133606; G02F 1/1334

(57) ABSTRACT

The present application provides a dimming layer for a display module and the display module, wherein a side surface of the dimming layer is formed with nano-pillars arranged in an array, and wherein the dimming layer is configured to pass through incident light perpendicular to a surface of the dimming layer and is configured to absorb incident light not perpendicular to the surface of the dimming layer. A light propagation direction is modulated by the dimming layer to achieve adjustment between wide and narrow viewing angles.

### TECHNICAL FIELD

The present invention relates to a field of display technology and more particularly to a dimming layer for a display module and the display module.

### BACKGROUND

With rapid development of display technology, use of display devices is ubiquitous in daily life. In the past, wide viewing angles were considered to be an advantage of mobile phones and personal computers (PC). However, as consumers' awareness of privacy increases, in special situations, such as on subways, high-speed rails, airplanes, etc., people want privacy to be protected. Therefore, a single wide viewing angle of display devices can no longer meet people's requirements. It is necessary to provide a display that can be switched between a wide viewing angle mode and a narrow viewing angle mode. Thereby, people can switch their display to the narrow viewing angle mode when they do not want people around to watch content on their displays and switch their displays to the wide viewing angle mode when they do not mind people around watching content on their displays.

Therefore, there is an urgent need fora dimming layer fora display module and the display module to solve the above technical problems.

### SUMMARY OF INVENTION

### Technical Problem

The embodiments of the present application provide a dimming layer for a display module and the display module, to solve the above technical problems of switching the display to a narrow viewing angle mode when people don't want people around to watch content on their display, and switching the display to a wide viewing angle mode when people don't mind people around to watch content on their display.

### Solution to Technical Problem

### Technical Solution

In order to solve the above technical problems, the technical solutions provided by the present application are as follows:

The present application provides a dimming layer for a display module, wherein a side surface of the dimming layer is formed with nano-pillars arranged in an array, and wherein the dimming layer is configured to pass through incident light perpendicular to a surface of the dimming layer and is configured to absorb incident light not perpendicular to the surface of the dimming layer.

In one embodiment, the dimming layer includes a first dimming region and a second dimming region, and a size of the nano-pillars of the first dimming region is different from a size of the nano-pillars of the second dimming region.

In one embodiment, a greatest cross-sectional dimension of the nano-pillars ranges from 80 nm to 180 nm, and a height of the nano-pillars is 80 nm.

In one embodiment, the dimming layer includes a first dimming region and a second dimming region, and a density of the nano-pillars in the first dimming region is different from a density of the nano-pillars in the second dimming region.

In one embodiment, a distance between adjacent two of the nano-pillars ranges from 160 nm to 380 nm

In one embodiment of the present invention, the dimming layer includes a substrate, and the nano-pillars are formed on the substrate.

In one embodiment, a material of the nano-pillars is silver or titanium dioxide.

In one embodiment, a cross-sectional shape of the nano-pillars includes a circle, a rectangle, a triangle, or a trapezoid.

In one embodiment, the nano-pillars arranged in the array include a plurality of nano-pillar arrays arranged in a lattice, and wherein a geometric shape of the nano-pillar arrays includes at least one of a square, a hexagon, an octagon, or a pentagon.

The present application further provides a display module, including:
a backlight module;
a display panel positioned on a light-emitting side of the backlight module; and
a dimming layer positioned on a light-emitting side of the display panel;
wherein a side surface of the dimming layer is formed with nano-pillars arranged in an array, and wherein the dimming layer is configured to pass through incident light perpendicular to a surface of the dimming layer, and is configured to absorb incident light not perpendicular to the surface of the dimming layer.

In one embodiment, the dimming layer includes a first dimming region and a second dimming region, and a size of the nano-pillars of the first dimming region is different from a size of the nano-pillars of the second dimming region.

In one embodiment, a greatest cross-sectional dimension of the nano-pillars ranges from 80 nm to 180 nm, and a height of the nano-pillars is 80 nm.

In one embodiment, the dimming layer includes a first dimming region and a second dimming region, and a density of the nano-pillars in the first dimming region is different from a density of the nano-pillars in the second dimming region.

In one embodiment, a distance between adjacent two of the nano-pillars ranges from 160 nm to 380 nm.

In one embodiment, the dimming layer includes a substrate, and the nano-pillars are formed on the substrate.

In one embodiment, a material of the nano-pillars is silver or titanium dioxide.

In one embodiment, a cross-sectional shape of the nano-pillars includes a circle, a rectangle, a triangle, or a trapezoid.

In one embodiment, the nano-pillars arranged in the array include a plurality of nano-pillar arrays arranged in a lattice, and wherein a geometric shape of the nano-pillar arrays includes at least one of a square, a hexagon, an octagon, or a pentagon.

In one embodiment, the display module further including a liquid crystal layer positioned in the backlight module or between the backlight module and the display panel;
wherein the liquid crystal layer includes a first electrode and a second electrode oppositely arranged, and a liquid crystal molecular layer positioned between the first electrode and the second electrode, and the liquid crystal molecular layer switches between a scattering state and a transparent state under an electric field formed between the first electrode and the second electrode.

In one embodiment, a material of the liquid crystal molecular layer is polymer dispersed liquid crystal or polymer network liquid crystal.

### Beneficial Effects of Invention

### Beneficial Effects

One side surface of the dimming layer is formed with nano-pillars arranged in an array so that the dimming layer can transmit incident light perpendicular to the surface of the dimming layer and absorb incident light that is not perpendicular to the surface of the dimming layer, therefore, modulating a propagation direction of light by the dimming layer, and using the liquid crystal layer located in the backlight module or between the backlight module and the display panel to realize real-time control of wide and narrow viewing angles

### BRIEF DESCRIPTION TO DRAWINGS

### Description of Drawings

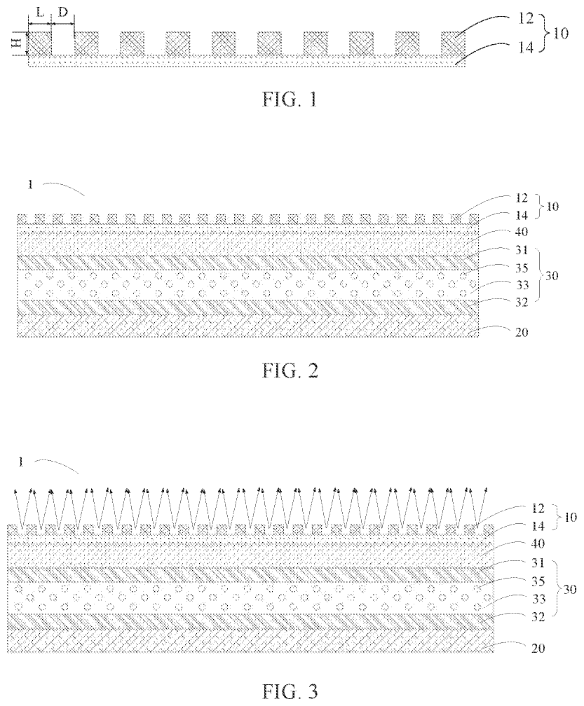

FIG. 1 is a schematic structural diagram of a dimming layer for a display module provided by one embodiment of the present invention.

FIG. 2 is a schematic structural diagram of a display module provided by one embodiment of the present invention.

FIG. 3 is a schematic diagram of an optical path when a liquid crystal molecular layer is in a scattering state according to one embodiment of the present invention.

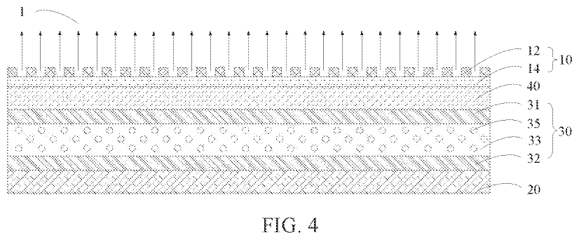

FIG. 4 is a schematic diagram of an optical path when the liquid crystal molecular layer is in a transparent state according to one embodiment of the present invention.

### EMBODIMENTS OF INVENTION

### Detailed Description of Embodiments

The present application provides a dimming layer for a display module and the display module. In order to make the objectives, technical solutions, and effects of the present application more specific and clearer, the present application will be further described in detail below with reference to the accompanying figures and embodiments. It should be understood that the specific embodiments described here are only used to explain the present disclosure, and are not used to limit the present application.

The embodiments of the present application provide a display panel and a manufacturing method thereof. Detailed descriptions are provided below. It should be noted that an order of description in the following embodiments is not meant to limit a preferred order of the embodiments.

As shown in FIG. 1, one embodiment of the present invention provides a dimming layer 10 for a display module, wherein a side surface of the dimming layer 10 is formed with nano-pillars 12 arranged in an array, and wherein the dimming layer 10 is configured to transmit incident light perpendicular to a surface of the dimming layer 10 and is configured to absorb incident light not perpendicular to the surface of the dimming layer 10. Specifically, due to the characteristics of a structure of the nano-pillar 12 itself, a phase and amplitude of the incident light can be adjusted, when an incident direction of the incident light matches the structure of the nano-pillar 12, the structural characteristics of the nano-pillar 12 can be used to change a reflection phase of the incident light. By changing the design of the nano-pillars 12, reflection phase of the incident light can be changed, thereby achieving an effect of adjusting an angle of any wavelength within a visible spectrum.

A material of the nano-pillar 12 is not limited, and the material of the nano-pillar 12 should be a material with higher reflectivity, such as silver (Ag), copper (Cu), or polycarbonate resin composition.

In this embodiment, by specially designing the nano-pillars 12 formed on the side surface of the dimming layer 10 (such as adjusting a shape, a size, a direction, or a position arrangement of the nano-pillars 12), control of a propagation direction of light (reflection/refraction) can be realized, thereby transmitting or absorbing light in a specific propagation direction. In this embodiment, the nano-pillars 12 arranged in the array can enable the dimming layer 10 to transmit incident light perpendicular to the surface of the dimming layer 10 and absorb incident light that is not perpendicular to the surface of the dimming layer 10. The propagation direction of light is modulated by the dimming layer 10 to achieve adjustment between wide and narrow viewing angles.

A cross-sectional shape of the nano-pillars 12 includes patterns such as a circle, a rectangle, a triangle, or a trapezoid. The pattern arrangement parameters, length, width, height, spacing, position angle, etc. are related to angle of incident light, the present invention does not limit it.

Further, the nano-pillars 12 arranged in the array may include a plurality of nano-pillar arrays arranged in a lattice, and wherein a geometric shape of the nano-pillar arrays may include at least one of a square, a hexagon, an octagon, or a pentagon.

In one embodiment, an interval between adjacent two of the nano-pillars 12 of the nano-pillar arrays can be selected to achieve a control of a propagation (reflection/refraction) direction of light and selectively transmit or absorb light in a specific direction.

In another embodiment, a size of the nano-pillars 12 of the nano-pillar array can be selected to achieve control of a propagation (reflection/refraction) direction of light and selectively transmit or absorb light in a specific propagation direction.

In one specific implementation method, one embodiment of the present invention provides a dimming layer 10 for a display module. The dimming layer 10 includes a substrate 14, and the nano-pillars 12 are formed on the substrate 14, wherein the substrate 14 can be a separate film, or can be a residual film from an embossing process. Because glue has a certain refractive index, glue with a corresponding refractive index can be selected according to actual needs to prevent affecting a propagation direction of light.

In one embodiment, the nano-pillars 12 can be manufactured by using electron beam etching or other appropriate nano-level writing technology and/or devices. In another embodiment, the nano-pillars 12 may be molded onto the appropriate substrate 14 by printing, impressing, relief, embossing, molding, or other forming methods to form the dimming layer 10.

In one specific implementation method, one embodiment of the present invention provides a dimming layer 10 for a display module, wherein the dimming layer 10 includes a first dimming region and a second dimming region, and a size of the nano-pillars 12 of the first dimming region is different from a size of the nano-pillars 12 of the second dimming region. Specifically, as shown in FIG. 1, the dimension parameters of the nano-pillars 12 may include a maximum cross-sectional dimension (L) and a height (H). In this embodiment, the maximum cross-sectional dimension of the nano-pillars 12 may be determined according to a propagation direction of the incident light. By designing a size of the nano-pillars 12 in the dimming layer 10 in partitions, precise partition control of a propagation direction of light can be achieved.

Optionally, the greatest cross-sectional dimension (L) of the nano-pillars 12 ranges from 80 nm to 180 nm, and the height (H) of the nano-pillar 12 is 80 nm.

In one specific implementation method, one embodiment of the present invention provides a dimming layer 10 for a display module. The dimming layer 10 includes a first dimming region and a second dimming region, and a density of the nano-pillars 12 in the first dimming region is different from a density of the nano-pillars 12 in the second dimming region. By designing the density of the nano-pillars 12 in the dimming layer 10 in partitions, it can achieve an effect of precise partition control of a propagation direction of light, which significantly improves a light utilization rate.

Optionally, a distance (D) between adjacent two of the nano-pillars 12 ranges from 160 nm to 380 nm.

In one specific implementation method, one embodiment of the present invention provides a dimming layer 10 for a display module, and a material of the nano-pillars 12 is silver or titanium dioxide, wherein titanium dioxide is a dielectric material with high refractive index in a visible light range, which can phase-modulate incident light within a range from 0° to 360°.

In one specific implementation method, one embodiment of the present invention provides a display module. As shown in FIG. 2, the display module 1 includes a backlight module 20, a display panel 40 positioned on a light-emitting side of the backlight module 20, and a dimming layer 10 positioned on a light-emitting side of the display panel 40, wherein the dimming layer 10 is the dimming layer 10 in the above-mentioned embodiment. The backlight module 20 is disposed under the display panel 40 and is configured to provide a light source in a direction of the display panel 40. The dimming layer 10 modulates a light propagation direction on the light-emitting side of the display panel 40 to realize adjustment between the wide and narrow viewing angles of the display module.

In the display module provided by the embodiment of the present invention, the backlight module 20 includes a light guiding plate and a light source. Optionally, the light source may be an edge light source or a direct light source. Correspondingly, the light guiding plate may also be an edge light guiding plate or a direct light guiding plate. Further, the backlight module 20 may also include a prism sheet, a diffuser sheet, a reflective sheet, and a sealant, wherein the prism sheet, the diffuser sheet, the light guiding plate, and the reflective sheet are stacked in sequence along a light-emitting direction away from the display panel 40, and the sealant is set around the light guiding plate. The prism sheet is configured to improve a luminous efficiency of an entire backlight system; the diffuser sheet can be used to enhance optical quality and can also be used to improve an adsorption phenomenon of the film and other parts of the display panel 40; the light guiding plate is configured to guide the light emitted by the light source and then provide uniform backlight to the display panel 40; the reflective sheet is configured to control reflection and refraction of light, so that the light path is controllable, and the brightness of the display panel 40 can be more uniform, disposing the above film layers can make the display panel 40 achieve a better display effect with lower power consumption.

In one specific implementation method, one embodiment of the present invention provides a display module. As shown in FIG. 2, the display module 1 further includes a liquid crystal layer 30 positioned in the backlight module 20 or between the backlight module 20 and the display panel 40, wherein the liquid crystal layer 30 includes a first electrode 31 and a second electrode 32 oppositely arranged, and a liquid crystal molecular layer 33 positioned between the first electrode 31 and the second electrode 32, and the liquid crystal molecular layer 33 switches between a scattering state and a transparent state under influence of an electric field formed between the first electrode 31 and the second electrode 32. Specifically, under the influence of the electric field formed by the first electrode 31 and the second electrode 32, the liquid crystal molecular layer 33 is in a transparent state, and the light from the light-emitting side of the backlight module does not scatter or refract when passing through the liquid crystal layer 30, and the light is emitted according to the original path at this time; when there is no electric field between the first electrode 31 and the second electrode 32, the liquid crystal molecular layer 33 is in the scattering state, and when the light from the light-emitting side of the backlight module passes through the liquid crystal layer 30, the light path changes and the light is scattered into light in various directions.

The first electrode 31 and the second electrode 32 are both transparent electrodes. Optionally, a material of the first electrode 31 and the second electrode 32 is nano silver, graphene, ITO (indium tin oxide), nano-material composite film or two-dimensional material film.

Illustratively in FIG. 2, the liquid crystal layer 30 is positioned between the backlight module 20 and the display panel 40. In other implementation methods, the liquid crystal layer 30 may also be positioned in the backlight module 20. As shown in FIG. 2, when an electric field is formed between the first electrode 31 and the second electrode 32, the liquid crystal molecular layer 33 is in a transparent state, and the light from the light-emitting side of the backlight module 20 does not scatter or refract when passing through the liquid crystal layer 30. At this time, the light is emitted according to an original path. The light emitted from the display panel 40 is mainly light perpendicular to the surface of the display panel, and a small amount of light whose propagation direction is not perpendicular to the surface of the display panel is emitted and the light propagation direction is modulated by the dimming layer 10. The light perpendicular to the surface of the dimming layer 10 is directly transmitted therethrough, while the small amount of light that is not perpendicular to the surface of the dimming layer 10 is absorbed by the dimming layer 10. Finally, only the light perpendicular to the surface of the dimming layer 10 is emitted from the display module 1. In observers' fields of vision, only from a front view direction can they see the display, while from other angles they cannot see the display, so as to achieve narrow viewing angle display. When there is no electric field between the first electrode 31 and the second electrode 32, the liquid crystal molecular layer 33 is in a scattering state, when the light on the light-emitting side of the backlight module 20 passes through the liquid crystal layer 30, the light path changes and is scattered into light in various directions. Therefore, the light through and emitted from the display panel 40 is also scattered light, and finally passes through the dimming layer 10. Due to the dimming layer 10 can only absorb a small amount of light incident non-perpendicular to its surface, the remaining light incident non-perpendicular to its surface passes through the dimming layer 10 directly. Shown in the observers' fields of vision, not only can the display be observed from the front view, but the display can also be observed from other directions, so as to achieve wide viewing angle display. In this embodiment, the display module 1 can realize freely switching between wide viewing angle and narrow viewing angle, which makes up for the defect that current display devices cannot switch between a wide viewing angle mode and a narrow viewing angle mode.

The display module 1 provided by the embodiments of the present invention uses disposition of the liquid crystal molecular layer 33 that can be switched between the transparent state and the scattering state and the dimming layer 10 configured to adjust the light propagation paths to realize wide and narrow viewing angle modulation. When the liquid crystal molecular layer 33 is in the transparent state, the light perpendicular to the surface of the dimming layer 10 is directly transmitted, while a small amount of light that is not perpendicular to the surface of the dimming layer 10 is absorbed by the dimming layer 10 to realize narrow viewing angle display of the display module; when the liquid crystal molecular layer 33 is in the scattering state, a large amount of light that is not perpendicular to its surface directly passes through the side of the dimming layer 10, to realize the wide viewing angle display of the display module 1. Thereby the display module 1 can be freely switched between the wide viewing angle mode and the narrow viewing angle mode, which makes up for the defect that current display devices cannot switch between the wide viewing angle mode and the narrow viewing angle mode.

In one specific implementation method, one embodiment of the present invention provides a display module, the liquid crystal layer 30 includes a driving circuit, and the driving circuit is electrically connected to the first electrode 31 and the second electrode 32, the driving circuit is configured to control the liquid crystal molecular layer 33 to switch between the transparent state and the scattering state. Specifically, when the display module 1 is used for wide viewing angle display, the first electrode 31 and the second electrode 32 are driven by the driving circuit to switch the liquid crystal molecular layer 33 into the scattering state, a light path of the light on the light-emitting side of the backlight module 20 passes through the liquid crystal layer 30 is changed and is scattered into light in various directions; when the display module 1 is used for narrow viewing angle display, the driving circuit provides a driving voltage to the first electrode 31 and the second electrode 32, to switch the liquid crystal molecular layer 33 into the transparent state. The light on the light-emitting side of the backlight module 20 does not scatter or refract when passing through the liquid crystal layer 30, and the light is emitted according to the original path at this time.

The driving circuit may be formed on a flexible circuit board.

It is understandable that, as described above, the liquid crystal molecular layer 33 is in the transparent state by applying a voltage on the first electrode 31 and the second electrode 32, so that the first electrode 31 and the second electrode 32 are in the transparent state. The control method of controlling the liquid crystal molecular layer 33 in the scattering state without an electric field is only an example, and other control methods may also be adopted. For example, the first electrode 31 and the second electrode 32 can be under influence of a voltage difference to make the liquid crystal molecular layer 33 be in the transparent state, the first electrode 31 and the second electrode 32 can make the liquid crystal molecular layer 33 be in the scattering state under another voltage difference, as long as the electric field between the first electrode 31 and the second electrode 32 controls the liquid crystal molecular layer 33 to switch between the transparent state and the scattering state.

In one specific implementation method, one embodiment of the present invention provides a display module, wherein a material of the liquid crystal molecular layer 33 is polymer dispersed liquid crystal or polymer network liquid crystal. By utilizing the characteristic of polymer dispersed liquid crystal or polymer network liquid crystal that they can be switched between the transparent state and the scattering state, combined with the function of the dimming layer 10 of modulating the light propagation direction, real-time regulation of the wide and narrow viewing angles of the display module 1 is realized.

Polymer dispersed liquid crystal (PDLC)/Polymer network liquid crystal (PNLC) are all polymer/liquid crystal composite films. PDLC is a mixture of low-molecular liquid crystal and prepolymer, under certain conditions, after polymerization, a formation of micron-sized liquid crystal particles 35 uniformly dispersed in a polymer network, and then use a dielectric anisotropy of the liquid crystal molecules to obtain electro-optic response characteristics of the material. PDLC has a structure in which the liquid crystal is dispersed through the polymer, i.e., the liquid crystal is phase separated in the polymer; PNLC has a structure in which liquid crystals are dispersed in the polymer network, and the liquid crystals in the polymer network have a continuous phase. As the polymer layer, a light-curing resin can be used. For example, PNLC includes irradiating a solution in which a liquid crystal is mixed with a photopolymerizable polymer precursor (monomer) with ultraviolet rays to polymerize the monomer to form a polymer, and the liquid crystal is dispersed in the polymer network.

For PNLC, in an off state, i.e., when an electric field is zero, since the liquid crystal exists in a multi-domain state in the network, a director distribution of each liquid crystal domain is random, and the incident light is scattered due to a discontinuous change of the refractive index at the interface between the domain and the domain, and the PNLC appears as a scattered state; when a voltage is applied to the PNLC, the electric field causes the directors in all the liquid crystal domains to be arranged in a single domain state along a direction of the electric field. For incident light, it is a medium with a uniform refractive index, the PNLC transmits light under sufficient voltage, in the case, if the electric field has sufficient intensity, a vertical transmittance of the PNLC will reach a maximum, and the PNLC will be in the transparent state.

As shown in FIGS. 3 and 4, taking the material of the liquid crystal molecular layer 33 as a polymer dispersed liquid crystal as an example, in this embodiment, the polymer liquid crystal includes liquid crystal particles 35 uniformly distributed therein. Specifically, when no electric field is formed between the first electrode 31 and the second electrode 32, optical axis orientations of the liquid crystal particles 35 in the PDLC are random, at this time, the PDLC is in the scattering state. When an electric field is formed between the first electrode 31 and the second electrode 32, the liquid crystal in the PDLC is oriented perpendicular to the display panel 40 along the direction of the electric field, and an effective refractive index of the liquid crystal particles 35 basically matches a refractive index of the polymer. At this time, the PDLC is in the transparent state. Through the electric field between the first electrode 31 and the second electrode 32, the dimming layer 311 can be controlled to switch between the transparent state and the scattering state.

As shown in FIG. 3, after the external voltage is applied, the optical axis of the liquid crystal particles 35 is aligned perpendicular to the PDLC surface, i.e., consistent with the direction of the electric field. The effective refractive index of the liquid crystal particles basically matches the refractive index of the polymer, therefore there is no obvious interface, forming a basically uniform medium, so the incident light will not be scattered. At this time, the liquid crystal molecular layer 33 is in the transparent state, and there is no scattering or refraction when the light from the light-emitting side of the backlight module passes through the liquid crystal layer 30. At this time, the light is emitted according to the original path, therefore the light emitted from the display panel 40 is mainly the light perpendicular to the surface of the display panel 40, and a small amount of light that is not perpendicular to the surface of the display panel 40 is emitted, and then the dimming layer modulates a propagation direction of the small amount of light that is not perpendicular to the surface of the display panel 40. Therefore, the light perpendicular to the surface of the dimming layer 10 is directly transmitted, while the small amount of light that is not perpendicular to the surface of the dimming layer 10 is absorbed by the dimming layer 10, and finally only the light perpendicular to the surface of the dimming layer 10 is emitted from the display module 1 and is shown in the observers' fields of vision, the display can be seen only in a direction of the front viewing angle, while the display cannot be seen in other viewing angles, thus achieving narrow viewing angle display.

In the case of no applied voltage, as shown in FIG. 4, the optical axis orientation of the liquid crystal particles 35 are random and presented in a disorderly state. The effective refractive index of the liquid crystal particles 35 does not match the refractive index of the polymer, which causes the incident light to be strongly scattered. At this time, the liquid crystal molecular layer 33 is in the scattering state, and the path of the light from the light-emitting side of the backlight module 20 changes when passing through the liquid crystal layer 30 and is scattered into light in various directions. By the display panel 40, the light emitted from the display panel 40 is also scattered light and finally passes through the dimming layer 10. Since the dimming layer 10 can only absorb a small amount of incident light non-perpendicular to its surface, the remaining non-perpendicular light on the surface passes the dimming layer 10 directly and is shown in the observers' fields of vision. Not only can the display be observed from the front viewing angle, but the display can also be observed from other directions, thereby realizing wide viewing angle display. In this embodiment, the characteristic that the polymer dispersed liquid crystal or the polymer network liquid crystal can be switched between the transparent state and the scattering state, combined with the function of the dimming layer 10 of modulating the light propagation direction, the display module 1 realizes freely switching between the wide and narrow viewing angles and makes up for the defect that current display devices cannot be switched between the wide viewing angle mode and the narrow viewing angle mode.

The embodiment of the present invention provides a driving method of a display module for driving the display module as described above, wherein the driving circuit is electrically connected to the first electrode 31 and the second electrode 32, so the driving circuit is configured to control the liquid crystal molecular layer 33 to switch between the transparent state and the scattering state. The display module 1 has a wide viewing angle mode and a narrow viewing angle mode. In the wide viewing angle mode, the liquid crystal molecular layer 33 is switched into the scattering state, and light is incident on the dimming layer 10, and the dimming layer 10 absorbs a small amount of light not perpendicular to the surface of the dimming layer 10, and the remaining large amount of light that is not perpendicular to the dimming layer 10 surface passes through the dimming layer 10 directly, thereby achieving wide viewing angle display. In the narrow viewing angle mode, the liquid crystal molecular layer 33 is switched into the transparent state, and the light perpendicular to the surface of the dimming layer 10 is directly transmitted, while a small amount of light that is not perpendicular to the surface of the dimming layer 10 is absorbed by the dimming layer 10, thereby realizing narrow viewing angle display.

The driving method of the display device includes the following steps: in the wide viewing angle mode, the liquid crystal molecular layer 33 is driven by the driving circuit to be switched into the scattering state, so that a large amount of light that is not perpendicular to the dimming layer 10 surface directly passes through the side of the dimming layer 10 to realize wide viewing angle display of module 1. In the narrow viewing angle mode, a driving voltage is provided, and the liquid crystal molecular layer 33 is driven by the driving circuit to be switched into the transparent state, so that the light perpendicular to the surface of the dimming layer 10 is directly transmitted, a small amount of light that is not perpendicular to the surface of the dimming layer 10 is absorbed by the dimming layer 10 to realize narrow viewing angle display of the display module 1.

With this driving method, the display module 1 can realize free switching between the wide viewing angle mode and the narrow viewing angle mode, thereby providing selective privacy content protection for the display, allowing surrounding viewers to watch the content that the controller wants to let them watch, thereby realizing intelligent control.

In summary, the present invention provides a dimming layer fora display module and the display module, wherein a side surface of the dimming layer is formed with nano-pillars arranged in an array, and wherein the dimming layer is configured to pass through incident light perpendicular to a surface of the dimming layer and is configured to absorb incident light not perpendicular to the surface of the dimming layer. The display module includes a backlight module, a display panel positioned on a light-emitting side of the backlight module, and a dimming layer positioned on a light-emitting side of the display panel, and a liquid crystal layer positioned in the backlight module or between the backlight module and the display panel, by utilizing the characteristic of the liquid crystal layer that it can be switched between a transparent state and a scattering state, combined with a function of the dimming layer which can modulate a light propagation direction, real-time control of wide and narrow viewing angles of the display module is realized. When the liquid crystal molecular layer is in the transparent state, the light perpendicular to the surface of the dimming layer is directly transmitted, and a small amount of light that is not perpendicular to the surface of the dimming layer is absorbed by the dimming layer to realize narrow viewing angle display of the display module; when the liquid crystal molecular layer is in the scattering state, a large amount of light that is not perpendicular to its surface directly passes through one side of the dimming layer to realize the wide viewing angle display of the display module. At the same time, by disposing the driving circuit, the display module can be freely switched between a wide viewing angle mode and a narrow viewing angle mode, thereby meeting people's needs for privacy and confidential display functions.

It can be understood that, for those of ordinary skill in the art, equivalent replacements or changes can be made according to the technical solution of the present application and its inventive concept, and all these changes or replacements shall fall within the protection scope of the appended claims of the present application.

1. A dimming layer for a display module, wherein a side surface of the dimming layer is formed with nano-pillars arranged in an array, and wherein the dimming layer is configured to pass through incident light perpendicular to a surface of the dimming layer and is configured to absorb incident light not perpendicular to the surface of the dimming layer.

2. The dimming layer according to claim 1, wherein the dimming layer comprises a first dimming region and a second dimming region, and a size of the nano-pillars of the first dimming region is different from a size of the nano-pillars of the second dimming region.

3. The dimming layer according to claim 2, wherein a greatest cross-sectional dimension of the nano-pillars ranges from 80 nm to 180 nm, and a height of the nano-pillars is 80 nm.

4. The dimming layer according to claim 1, wherein the dimming layer comprises a first dimming region and a second dimming region, and a density of the nano-pillars in the first dimming region is different from a density of the nano-pillars in the second dimming region.

5. The dimming layer according to claim 4, wherein a distance between adjacent two of the nano-pillars ranges from 160 nm to 380 nm.

6. The dimming layer according to claim 1, wherein the dimming layer comprises a substrate, and the nano-pillars are formed on the substrate.

7. The dimming layer according to claim 1, wherein a material of the nano-pillars is silver or titanium dioxide.

8. The dimming layer according to claim 1, wherein a cross-sectional shape of the nano-pillars comprises a circle, a rectangle, a triangle, or a trapezoid.

9. The dimming layer according to claim 1, wherein the nano-pillars arranged in the array comprise a plurality of nano-pillar arrays arranged in a lattice, and wherein a geometric shape of the nano-pillar arrays comprises at least one of square, a hexagon, an octagon, or a pentagon.

10. A display module, comprising:
a backlight module;
a display panel positioned on a light-emitting side of the backlight module; and
a dimming layer positioned on a light-emitting side of the display panel;
wherein a side surface of the dimming layer is formed with nano-pillars arranged in an array, and wherein the dimming layer is configured to pass through incident light perpendicular to a surface of the dimming layer and is configured to absorb incident light not perpendicular to the surface of the dimming layer.

11. The display module according to claim 10, wherein the dimming layer comprises a first dimming region and a second dimming region, and a size of the nano-pillars of the first dimming region is different from a size of the nano-pillars of the second dimming region.

12. The display module according to claim 11, wherein a greatest cross-sectional dimension of the nano-pillars ranges from 80 nm to 180 nm, and a height of the nano-pillars is 80 nm.

13. The display module according to claim 10, wherein the dimming layer comprises a first dimming region and a second dimming region, and a density of the nano-pillars in the first dimming region is different from a density of the nano-pillars in the second dimming region.

14. The display module according to claim 13, wherein a distance between adjacent two of the nano-pillars ranges from 160 nm to 380 nm.

15. The display module according to claim 10, wherein the dimming layer comprises a substrate, and the nano-pillars are formed on the substrate.

16. The display module according to claim 10, wherein a material of the nano-pillars is silver or titanium dioxide.

17. The display module according to claim 10, wherein a cross-sectional shape of the nano-pillars comprises a circle, a rectangle, a triangle, or a trapezoid.

18. The display module according to claim 10, wherein the nano-pillars arranged in the array comprise a plurality of nano-pillar arrays arranged in a lattice, and wherein a geometric shape of the nano-pillar arrays comprises at least one of a square, a hexagon, an octagon, or a pentagon.

19. The display module according to claim 10, further comprising:
a liquid crystal layer positioned in the backlight module or between the backlight module and the display panel;
wherein the liquid crystal layer comprises a first electrode and a second electrode oppositely arranged and a liquid crystal molecular layer positioned between the first electrode and the second electrode, and the liquid crystal molecular layer switches between a scattering state and a transparent state under influence of an electric field formed between the first electrode and the second electrode.

20. The display module according to claim 19, wherein a material of the liquid crystal molecular layer is polymer dispersed liquid crystal or polymer network liquid crystal.
